(19) United States
(12) Patent Application Publication
(10) Pub. No.: US 2016/0300231 A1
(43) Pub. Date: Oct. 13, 2016

(54) PUSH NOTIFICATION AUTHENTICATION PLATFORM FOR SECURED FORM FILLING

(71) Applicant: Abine, Inc., Boston, MA (US)

(72) Inventors: Robert SHAVELL, Boston, MA (US); Andrew SUDBURY, Somerville, MA (US); James PEERLESS, Boston, MA (US)

(21) Appl. No.: 14/683,447

(22) Filed: Apr. 10, 2015

(51) Int. Cl. G06Q 20/40; G06Q 20/38; H04L 29/06

(52) U.S. Cl. CPC G06Q 20/4016; H04L 63/08; H04L 63/12; G06Q 20/3821

(57) ABSTRACT

The present disclosure relates to systems and methods for notifying a user of attempts to provide masked credentials associated with the user to a third party, and for providing the user with an opportunity to approve or deny the attempt. The third party can be a website having a form field that receives the masked credential. The masked credential can include a telephone number, an email address, a mail address, a user name, a password, and funding account information (e.g., credit card or bank account numbers). Attempts to provide the masked credential using a device can be detected by an application installed on the device, and the notification can be implemented through a push notification sent to one or more devices registered with the user. Users can respond to the push notification by indicating whether the attempt to provide the masked credential is approved or denied.

### TECHNICAL FIELD OF THE INVENTION

The present invention relates to push notifications for authenticating a user's browsing activity between the user's terminal (computer, mobile device, tablet etc.) and related terminals (computer, mobile device, tablet etc.) capable of receiving notifications to authenticate the user's filling of forms on any third-party website.

### BACKGROUND OF THE INVENTION

Users of the Internet who choose to transact purchases, or provide email addresses or phone numbers to third party websites for various purposes must input credentials such as telephone numbers, email addresses, mail addresses, usernames, passwords, and other potentially sensitive or private information into preformatted fields on the third party website's forms used to collect said information. Once the information is input into the fields, the information can then be used to enable the user to receive content from the third party website or transact purchases on a merchant website.

While there are various protocols to ensure the user's privacy while providing sensitive information to online websites, there do not exist protocols that can notify a user that the user's information is being input into a website's form field or is being transferred via an NFC device or magnetic stripe device, and give the user the option to either allow or disallow the filling of the user's information. If an illegitimate user gains access to the legitimate user's sensitive information, the illegitimate user can use that sensitive information in forms, or conduct transactions in person, without the legitimate user's knowledge. In this way, the illegitimate user can trick a third party website or physical vendor into believing that it is communicating with the legitimate user, when, in fact, an illegitimate user is illegally using the legitimate owner's information for illegitimate purposes.

### Objectives and Advantages of the Invention

The present invention relates to an Internet user's filling information in form fields on third party websites and provides a tool installed on a device. The tool installed on the device ensures that each time a user (either legitimate or illegitimate) inputs information into a webform or transacts with a near field communication device or magnetic stripe device, the device with the installed tool can notify the legitimate user that a form is being filled on the user's behalf, or that a transaction is being undertaken. The notification to the legitimate user can appear on another device associated with the legitimate user. The notification can also give the legitimate user the option to allow or disallow the notified transaction.

Considering the foregoing, it is a primary objective of the present invention to ensure that a user (understood to be a user of the present invention), can have the ability to safeguard the user's data through an authentication system wherein the user must authenticate the input of the user's data in a third party website's form fill field or must approve of an online transaction or in person transaction via an NFC or magnetic stripe device.

It is a further objective of the present invention to provide a system and method that can prevent the misuse of a user's data by an illegitimate third party by providing the user software to allow the user to authenticate the input of credentials between the user's terminal, a third party Internet website, and the user's same or additional terminal.

It is a further objective of the present invention to provide a system and method that can prevent the misuse of a user's data by an illegitimate third party by providing the user software to prevent “phishing” of the user's data by sending a notification to one or more devices associated with the user, warning the user that there is a potential phishing attempt on the particular website at which the user is attempting to input data.

It is a further objective of the present invention to provide a system and method that can allow the user of the present invention to authenticate credentials provided to a third party website using the user's terminal. The user can authenticate the input of credentials using the user's terminal that provided the credentials to the third party website, or by using a separate, additional device associated with the user. It is also an objective of the present invention to allow the user to fill said website forms with masked information that is unique and different from the user's actual personally identifiable information.

It is a further objective of the present invention to provide a system and method that can prevent the misuse of a user's data by an illegitimate third party that has gained access to a first device associated with the user. When the illegitimate third party attempts to input credentials to a third party Internet website using the user's device, software on the user's device can send a push notification to a second device associated with the user. The push notification can notify the user that the user's first device is being used to input credentials to a third party website and can give the user the option to allow or disallow the transaction. This push notification can be sent to the user's second device without any indication or notification to the first device, and so the illegitimate user using the first device may have no knowledge that this push notification has taken place. Also, if the user disallows the transaction, the illegitimate user can have no knowledge that the transaction has been denied.

It is a further objective of the present invention to provide a system and method that can prevent third party tracking and compiling of a user's purchasing habits by allowing the purchaser to communicate in the same manner with a selected merchant as if the user had undertaken the normal, unprotected channel of transacting or providing personally identifiable information to the merchant. For example, it is an object of the present invention to provide a system and method that does not require a participating merchant to pre-register or obtain pre-approval from the operator of the presently disclosed system and method.

It is still a further objective of the present invention to provide a system and method that can prevent third party tracking and compiling of a user's purchasing habits that provides encrypted storage of its member's personal identity information that is obtained during registration and authenticated via the user's mobile device or tablet.

It is still a further objective of the present invention to provide a system and method that can prevent both third party tracking and compiling of a user's purchasing habits and identity theft that requires no change in habits, practices or processes of the merchant, while allowing the merchant to discern a fraudulent transaction and to halt any illegitimate transactions.

It is still a further objective of the present invention to provide a system and method that can prevent both third party tracking and compiling of a user's purchasing habits and identity theft by using a system of tokenization to protect the user's personally identifiable or payment information through the use of tokens.

It is still a further objective of the present invention to provide a system and method that can prevent both third party tracking and compiling of a user's purchasing habits and identity theft during an online purchase transaction, wherein the purchaser's responses to merchant checkout screens appear identical in kind to those of any new customer from the merchant's perspective, enhanced by the present invention's ability to detect, authenticate via the user's mobile device or tablet, and complete checkout forms entering into the selected field on the web page, in response to the received selection, an alternate piece of information for the user instead of the user's piece of personal information, the alternate piece of information being different from and a substitute for the user's piece of personal information, the alternate piece of information having been generated by one or more server computers in communication with the client computing device over a network.

It is still a further objective of the present invention to provide a system and method that can prevent theft of a purchaser's personal identity information during an online purchase transaction, and wherein the user is able to obtain a limited-balance/limited-duration credit card that can be created with tokenized information directly from the client software without the user having to navigate to other websites in order to create the limited-balance/limited-duration card, that the user can then authenticate via the user's terminal, and enter into the selected merchant form field. In some embodiments, the limited-balance/limited-duration card that can be created with tokenized information can be reused for multiple different merchants and for multiple different transactions; in other embodiments, the limited-balance/limited-duration card that can be created with tokenized information can be used for only one transaction or for one merchant.

It is still a further objective of the present invention to provide a system and method that can prevent both third party tracking and compiling of a user's purchasing habits and identity theft via near field communication devices and online mobile wallets that, in some embodiments, have the ability to notify the user of the account that a transaction with the user's information has been attempted via a near field communication device or via an online mobile wallet, and allow the legitimate owner of the information to either allow or disallow the transaction.

It is still a further objective of the present invention to provide a system and method that can prevent identity theft and can mitigate the chance of phishing attempts on third party websites by implementing an anti-fraud communication that is tied to user accounts and that can be transmitted to the applicable third party website via a notification tied to the user's account that can alert third party websites when phishing or identity theft is attempted at said website.

### SUMMARY OF THE INVENTION

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

According to one aspect, the present disclosure is directed at a transaction gateway for preventing fraud by enabling a user to control whether a masked transaction may be initiated with a third party, wherein the masked transaction is associated with a masked credential having a highly limited transaction history. The transaction gateway can comprise a data store for associating a user with at least one user device, and at least one computer processor coupled to the data store. The at least one computer processor can be configured to provide an interface to communicate with user devices, receive from a first user device a request to initiate the masked transaction by submitting to the third party the masked credential, wherein the masked credential is associated with the user, and to send to the at least one user device associated with the user a notification message requesting that the user approve or deny submission of the masked credential. The at least one computer processor can also be configured to receive a reply message from the at least one user device associated with the user indicating whether submission of the masked credential is approved or denied. If submission is approved, the at least one computer processor can be configured to allow initiation of the masked transaction by allowing submission of the masked credential. If submission is denied, the at least one computer processor can be configured to block initiation of the masked transaction by blocking submission of the masked credential.

According to some embodiments, the masked credential can include at least one of a masked email address, a masked mail address, a masked username, a masked password, a masked credit card number, a masked bank account number, and a masked phone number.

According to some embodiments, the at least one computer processor can be further configured to send an alert message indicating potentially fraudulent activity to the third party if submission of the masked credential is denied.

According to some embodiments, the at least one user device associated with the user can be different from the first user device.

According to some embodiments, the at least one user device associated with the user can be the same as the first user device.

According to some embodiments, the third party can comprise a website having a form for receiving the masked credential.

According to some embodiments, the at least one computer processor can be further configured to generate the masked credential associated with the user in response to the request from the first user device.

According to some embodiments, the at least one computer processor can be a previously generated masked credential stored in the data store, and the request from the first user device can include a request to retrieve the previously generated masked credential.

According to some embodiments, the at least one computer processor can allow submission of the masked credential by sending a message to the first user device that allows the first user device to submit the masked credential to the third party.

According to some embodiments, the at least one computer processor can block submission of the masked credential by sending a message to the first user device that blocks the first user device from submitting the masked credential to the third party.

According to another aspect, the present disclosure is directed at a method for preventing fraud by enabling a user to control whether a masked transaction may be initiated with a third party, wherein the masked transaction is associated with a masked credential having a highly limited transaction history. The method can comprise receiving, at a transaction gateway, a request from a first user device to initiate the masked transaction by submitting to the third party the masked credential, wherein the masked credential is associated with the user. The method can also comprise sending, from the transaction gateway, a notification message to at least one device associated with the user requesting that the user approve or deny submission of the masked credential, and receiving, at the transaction gateway, a reply message from the at least one user device associated with the user indicating whether submission of the masked credential is approved or denied. If submission is approved, the method can comprise allowing initiation of the masked transaction by allowing submission of the masked credential. If submission is denied, the method can comprise blocking initiation of the masked transaction by blocking submission of the masked credential.

According to some embodiments, the masked credential can include at least one of a masked email address, a masked mail address, a masked username, a masked password, a masked credit card number, a masked bank account number, and a masked phone number.

According to some embodiments, the method can further comprise sending an alert message indicating potentially fraudulent activity to the third party if submission of the masked credential is denied.

According to some embodiments, the at least one user device associated with the user can be different from the first user device.

According to some embodiments, the at least one user device associated with the user can be the same as the first user device.

According to some embodiments, the third party can comprise a website having a form for receiving the masked credential.

According to some embodiments, the masked credential associated with the user can be generated in response to the request from the first user device.

According to some embodiments, the masked credential can be a previously generated masked credential, and the request from the first user device can include a request to retrieve the previously generated masked credential.

According to some embodiments, allowing submission of the masked credential can comprise sending a message from the transaction gateway to the first user device that allows the first user device to submit the masked credential to the third party.

According to some embodiments, blocking submission of the masked credential can comprise sending a message from the transaction gateway to the first user device that blocks the first user device from submitting the masked credential to the third party.

### BRIEF DESCRIPTION OF THE DRAWINGS

A clear understanding of the key features of the inventions summarized above may be had by reference to the appended drawings, which illustrate the method and system of the invention, although it can be understood that such drawings depict preferred embodiments of the invention and, therefore, are not to be considered limiting its scope with regards to other embodiments which the invention is capable of contemplating. Accordingly:

FIG. 1 is a system diagram showing the interaction between a user terminal, a merchant's webpage, a privacy tool client, and transaction gateway platforms that support the privacy tool client, according to some embodiments.

FIG. 2 is a flowchart showing how a privacy tool interacts with a website's form, according to some embodiments.

FIGS. 3a and 3b are flowcharts illustrating a privacy tool's ability to allow a user to create a masked credit card for online transactions to block third party tracking of user purchases and authenticate the creation and filling of a masked credit card in a merchant's web checkout form. FIGS. 3a and 3b also illustrate how a user can use the privacy tool to alert the legitimate user to the fact that masked information is being created on the legitimate user's behalf, and how the legitimate user and account holder can either allow or disallow a transaction funded with masked payment information via the legitimate user's terminal according to some embodiments. FIGS. 3a and 3b also illustrate the process by which a notification can be sent to a third party website when an illegitimate party attempts to transact a masked purchase or automatically fill any personally identifiable information using a legitimate user's credentials occurs according to some embodiments.

FIG. 4 is an example of a mobile notification that can be sent to the legitimate user's connected devices containing a privacy tool.

FIG. 5 is an example of a desktop/computer notification that can be received by the legitimate user with a privacy tool installed in the user's internet browser.

FIG. 6 is an example of a privacy tool autofilling credit card information into a web form, while contemporaneously sending a push notification to the depicted user's connected device.

### DETAILED DESCRIPTION

In some embodiments, the present invention implements a suite of privacy tools (hereinafter “Privacy Tool”) that can be combined into an internet browser plugin and mobile device or tablet software application. The Privacy Tool can be directed at keeping a user's personally identifiable information private through push notification authentication of a user's online form filling activities through a mobile authentication server. The Privacy Tool can be embedded into one single piece of software and/or hardware, or can be implemented as multiple pieces of software and/or hardware (e.g., as part of a comprehensive privacy/anti-virus system securing an entire operating system, or network of computers). For ease of disposition, the following description focuses on the embodiments in which the Privacy Tool is implemented as and comprises (i) an internet browser extension plugin and/or mobile device or tablet software application (hereinafter “Privacy Tool application”), and (ii) a transaction gateway (hereinafter “Privacy Tool transaction gateway”) that communicates with the Privacy Tool application. However, the invention is not so limited.

According to some embodiments, to implement the Privacy Tool, the user can first download and install the Privacy Tool application onto a first device associated with the user. The first device can be a computer, tablet, or mobile device. The user can then create an account with the Privacy Tool transaction gateway. While creating the account, the user can provide the contact information of the first device (e.g., an IP address, email address, phone number, etc.) as well as an ID associated with the first device (e.g., “Work iPhone” or “Home Desktop”). The user can also optionally provide an ID and contact information for one or more other device associated with the user. For example, the user can register a second device (e.g., a computer, tablet or mobile device), and the contact information can comprise an email address, phone number, or other information that enables the Privacy Tool transaction gateway to communicate with the second device.

Once the Privacy Tool application has been installed on the first device and the account has been created with the Privacy Tool transaction gateway, the user can begin generating masked information. In general, masked information comprises information generated by the Privacy Tool transaction gateway that can be used as a replacement for legitimate user information when the user transacts with third parties, such as online or in-person merchants. The Privacy Tool transaction gateway can keep track of the linkage between masked information generated for the user, but the linkage can be kept secret from third parties to whom the masked information is provided. In this way, a third party that possesses only the generated masked information cannot independently locate or access the user's personal information. Many types of information can be masked, including email addresses, mail addresses, usernames, passwords, credit card numbers, bank account numbers, phone numbers, and other types of personal information. The technique of masking credentials in online transactions is described in further detail in U.S. patent application Ser. No. 14/253,281, filed Apr. 15, 2014, the contents of which are incorporated in its entirety herein.

One example of masked information is masked email addresses. Masked email addresses are computer-generated email addresses associated with email accounts that automatically forward received emails to the user's actual email inbox. The user can provide these masked email addresses instead of the user's real email address to third party websites that require an email address (e.g., for websites that require an email address to consummate a purchase transaction). To generate a masked email address, the user can provide the user's actual email address to the Privacy Tool. The Privacy Tool transaction gateway can then generate and provide masked email addresses whenever it is required to by the user's input.

The Privacy Tool can keep track of the masked email addresses that have been generated for a user. When a user attempts to access a third party website using the user's first device (on which the Privacy Tool application has been installed), and if the third party website requires an email address, the Privacy Tool can give the user a choice between providing one of the masked email addresses that have previously been generated for the user, generating a new masked email address, or using the user's actual, un-masked email address. When the user attempts to either use a previously generated masked email address or to generate a new masked email address using the first device, the Privacy Tool application on the user's first device can alert the Privacy Tool's transaction gateway. The Privacy Tool's transaction gateway can then look up the contact information of the second device associated with the same user, and send a push notification to the user's second device. This push notification alerts the user that someone is attempting to fill an email field on a third party website-using the user's first device, and can give the user an option to allow or disallow the transaction. If the user selects to disallow the transaction, the first device can be prohibited from filling in or providing the masked email address to the third party website. In this way, if an illegitimate user gains access to the user's first device and attempts to use the first device to fill in an email field on a third party website, the legitimate user can detect the attempt via the push notification to the user's second device and disallow the transaction. In some embodiments, the push notification to the user's second device can be implemented without any notification to the first device, and so the illegitimate user can have no knowledge that the legitimate user has received the push notification, or that the transaction has been denied. In other embodiments, the push notification can be sent to both the user's first and second devices, or to whichever device the user had previously designated for receiving push notifications. In embodiments where the user had registered multiple devices, the push notification can be sent to all or a subset of these devices, depending on the user's preconfigured preferences.

While the example described above pertains to masked email addresses, other embodiments of the Privacy Tool can also generate masked telephone numbers. Masked telephone numbers can be computer-generated telephone numbers associated with telephone accounts that automatically forward calls to the user's actual telephone number. In other embodiments, the Privacy Tool can also generate masked credit cards. Masked credit cards can be limited-duration, limited-balance credit cards that can be generated and funded by the Privacy Tool transaction gateway. In some embodiments, these masked credit cards can debit the user's actual funding account (e.g., the user's actual credit card, bank account, or online wallet account). When a user attempts to conduct online transactions using a credit card, the user can provide a masked credit card number instead of the user's actual credit card number, and in this way avoid having to input the user's potentially sensitive real credit card number. Just as with masked email addresses, if an illegitimate user gains access to the user's first device and attempts to fill in a third party website with a masked phone number or masked credit card number, the Privacy Tool transaction gateway can detect the attempt and notify the legitimate user by sending a push notification to the user's second device. The push notification can also give the user an option to allow or disallow the transaction. In some embodiments, the push notification to the user's second device can be implemented without any notification to the first device, and so the illegitimate user can have no knowledge that the legitimate user has received the push notification, or that the transaction has been denied. Also, just as with masked email addresses, the push notification can be sent to all or a subset of the user's registered devices.

According to some embodiments the Privacy Tool can prevent both third party tracking and compiling of a user's purchasing habits and identity theft via near field communication devices and online mobile wallets that, in some embodiments, have the ability to notify the user of the account that a transaction with the user's information has been attempted via a near field communication device or via the user's online mobile wallet, and allow the legitimate owner of the information to either allow or disallow the transaction. According to some embodiments the action from the user to disallow the transaction can also notify the merchant that additional transactions via the near-field communication device or online wallet are fraudulent and should be disallowed.

To mitigate the efforts of third party trackers and identity thieves, the user can use the Privacy Tool to ensure that data about the user's transactions are not compiled and resold to additional vendors or entities that profit from the compilation and reselling of user's browsing habits, or used illegally by identity thieves looking to profit from the use of the user's data. The user can also authenticate via the Privacy Tool each and every input of information through the communication between the Privacy Tool and the user's terminal Privacy Tool. In some embodiments, user data can be stored locally on the user's device in an encrypted data-store. In other embodiments, this encrypted data-store can also be synchronized across a user's multiple devices through a synchronization server which allows the user to create masked emails, phone numbers, and credit cards to block third-party tracking on any number of the user's electronic devices. In some embodiments, the user's data can also be tokenized to protect sensitive personally identifiable information. It should be noted that the Privacy Tool's ability to block third party tracking requires no input from the user, and the Privacy Tool can automatically block tracking each and every time the user navigates to a different website and provide push notification authentication to the user each and every time that the user interacts with a website's form field. It should further be noted that the Privacy tool can have a broader scope to prevent “phishing” of the user's data by notifying the user via the user's first device as well as by sending a push notification to the user's second device, warning the user that there is a potential phishing attempt on the particular website at which the user is attempting to input data.

Third-party websites can also implement the Privacy Tool on behalf of their customers to fight fraudulent attacks. The Privacy Tool can include an Anti-Fraud communication system that is tied to all users of the Privacy Tool. The Privacy Tool can detect fraudulent activity on a particular third-party's website and can send a notification to the owners of the website to alert them of a fraudulent attempt or attack made on the particular website.

Providing masked credentials (e.g., masked email addresses, telephone numbers, and credit card numbers) in place of real, personal credentials can be useful for preserving the user's privacy, but can also cause unique problems for conventional anti-fraud systems and techniques. For example, credit card companies typically employ fraud-detection schemes that rely on detecting transactions that do not conform to historical transaction patterns. These fraud detection schemes operate by analyzing and discerning patterns and trends in a credit card user's transactions, such as common transaction locations (e.g., the city in which transactions typically occur), typical dollar amounts, typical vendor types, etc. When a transaction occurs that does not fit the historical pattern (e.g., a transaction occurs in another city/country/geography, a transaction occurs with a much higher-than-usual dollar amount, a transaction occurs in a different currency, or a transaction occurs with an unusual vendor type), credit card companies can flag the transaction as potentially fraudulent. However, a masked credit card number could be specifically generated for a particular transaction or vendor, and so can be used for only a very small number of transactions. In some cases, the masked credit card number could be used only once, for a specific transaction. In these scenarios, typical fraud-detection schemes employed by credit card companies cannot build a rich enough transaction history to detect potentially fraudulent transactions. Therefore, an illegitimate user who gains access to a user's masked credit card number and who seeks to use it in an illegitimate transaction may not be detected by typical fraud detection schemes.

Similarly, the effectiveness of fraud detection schemes that rely on comparing present transactions against historical patterns can be diminished for other types of masked information (e.g., email addresses, telephone numbers, mail addresses, user names, passwords, etc.). As another example, websites that use require users to login with usernames, email addresses and passwords can keep track of the typical locations from which users login. These locations can comprise a typically seen IP address or set of IP addresses, a typical geographical location as determined by the GPS information from a mobile phone, or a typical country code. However, masked usernames, email addresses and passwords can be specifically generated for only one transaction or for a very limited set of transactions. When usernames and passwords are used infrequently, it can be difficult for conventional fraud-detection schemes to build a rich enough transaction history to detect potentially fraudulent transactions. Therefore, an illegitimate user who gains access to a user's masked username, email address or password may not be detected by such a conventional fraud detection scheme.

The presently disclosed systems, apparatus and methods for implementing push notification can address some of the limitations of these conventional fraud detection schemes by requiring authorization from the legitimate user before allowing a proposed transaction to proceed. The authorization from the legitimate user can be granted via a device other than the device that initiated the proposed transaction.

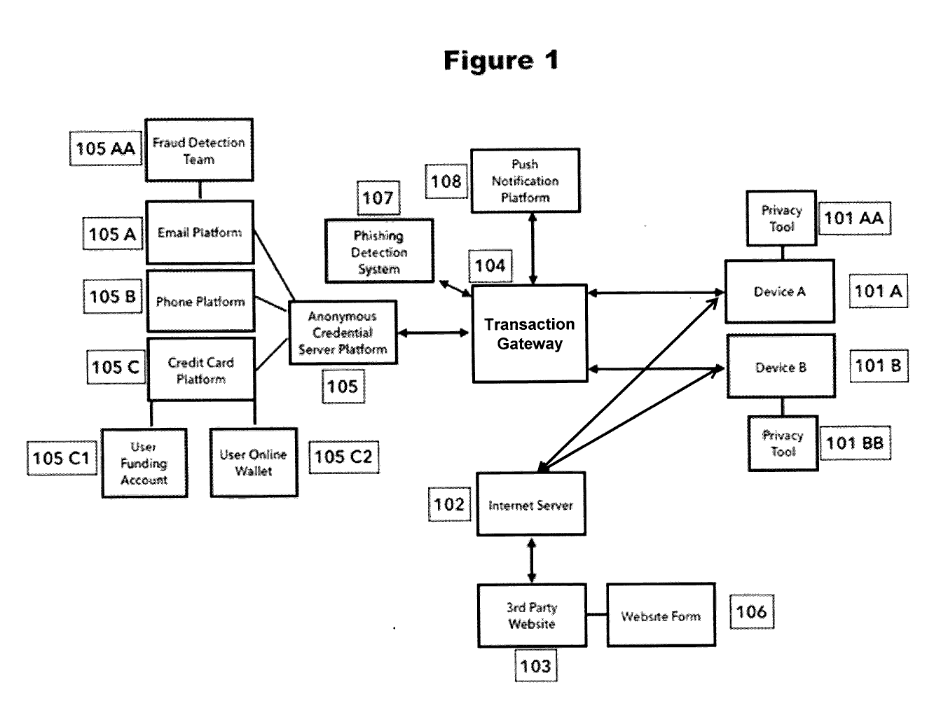

FIG. 1 is a system diagram showing the components of an exemplary Privacy Tool, according to some embodiments. FIG. 1 includes a Transaction Gateway 104, a push notification platform 108, a phishing detection system 107, an anonymous credential server platform 105 comprising an email platform 105A, a phone platform 105B, and a credit card platform 105C (connected to funding accounts 105C1 and/or user online wallet 105C2). FIG. 1 further includes a user terminal 101A on which a privacy tool application 101AA is installed, a user terminal 101B on which a privacy tool application 101BB is installed. FIG. 1 also includes an internet server 102 in communication with user terminals 101A and 101B, and which hosts a third party website 103. The third party website 103 can include a website form 106 that requests input of potentially sensitive user information, such as the user's email address, phone number, credit card information, or other sensitive or personal information.

The Transaction Gateway 104, push notification platform 108, phishing detection system 107, and anonymous credential server platform 105 (which can comprise email platform 105A, phone platform 105B, and/or credit card platform 105C) collectively implement the Privacy Tool transaction gateway discussed above. In some embodiments, each of these components can be integrated into one hardware device (e.g., a server), or can be implemented on multiple hardware devices that are connected by a network.

User terminal 101A and user terminal 101B can be devices that are both registered with the same user. In other embodiments, only one of these devices (e.g., user terminal 101B) can be registered with the legitimate user. Both user terminal 101A and user terminal 101B can be any personal computer or mobile device (e.g., smartphone or tablet) capable of connecting to the Internet. User terminal 101A can initiate contact with the Third Party Website (103) via the Internet Server 102. The Privacy Tool application 101AA can keep track of the websites to which the user navigates to on user's terminal 101A, and can forward this information to the Transaction Gateway 104. For example, if the user has decided to make a purchase or provide personally identifiable information to the third party website and has navigated to a Website Form (106), the Phishing Detection System (107) can compare the URL of the website to a list of known phishing websites and alert the user via a push notification that the user is in fact interacting with a known phishing website. The push notification can be sent to all or a subset of devices registered with the user (e.g., one or both of user terminals 101A and 101B). The user can then allow or disallow further input of information into the safe or phishing website.

The Privacy Tool application 101AA installed on the user's terminal 101A can also interact with Transaction Gateway 104 to provide masked credentials to the website form 106. For example, the Privacy Tool application 101AA can detect whether website form 106 (to which the user has navigated to using user terminal 101A) is requesting an email address, a phone number, a funding account number (e.g., a credit card number, a banking account number, or an account associated with an online wallet), a mail address, a username, a password, or some other type of personal or sensitive information. Privacy Tool application 101AA can then prompt the user with an option to provide a previously generated masked credential, or to generate a new masked credential. If the user provides input indicating that he would like to provide a previously generated masked credential, or a newly generated masked credential, Privacy Tool application 101AA can contact Transaction Gateway 104 and request masked credentials of the appropriate type. Transaction Gateway 104 would in turn contact the anonymous credential server platform 105. Depending on whether website form 106 is requesting an email address, a phone platform, or a credit card number, anonymous credential server 105 would then contact the appropriate platform (e.g., email platform 105A, phone platform 105B, and/or credit card platform 105C). If the user requested a previously generated masked credential, the appropriate platform can return the appropriate previously generated masked credential, which can be stored in memory at the platform. If the user requests a newly generated masked credential, the appropriate platform can return a newly generated masked credential (e.g., a newly generated masked email address, phone number, or credit card number). The appropriate masked credential can be returned by the appropriate platform to the anonymous credential server platform 105, which in turn forwards the credential to the Transaction Gateway 104.

In some scenarios, the masked credential can be supplied directly by the user of user terminal 101A. In these scenarios, there would be no need for the Privacy Tool 101AA to retrieve the masked credential from the Anonymous Credential Server Platform 105 via Transaction Gateway 104. In these scenarios, however, Privacy Tool 101AA would still be capable of recognizing that a user of user terminal 101A (whether legitimate or illegitimate) is inputting potentially sensitive information (e.g., an email address, funding account number, phone number, username or password) into a website's form field. When the Privacy Tool 101AA detects that this is the case, the Privacy Tool 101AA can send a confirmation request to the Transaction Gateway 104, alerting the Transaction Gateway 104 that someone is attempting to fill in potentially sensitive information and requesting authorization to proceed.

Once the Transaction Gateway 104 receives the correct type of information to fill via the Anonymous Credential Server Platform 105 (or, alternatively, once the Transaction Gateway 104 receives a confirmation request from the Privacy Tool 101AA that someone is attempting to fill in sensitive information associated with a registered, legitimate user), the Transaction Gateway 104 can, via the Push Notification Platform 108, send a push notification to some or all of the legitimate user's registered devices. The Push Notification Platform 108 can comprise a data store (e.g., a conventional database or distributed storage) holding records pertaining to multiple user accounts. Each user account can have one or more registered user devices (e.g., User Terminal 101A and User Terminal 101B). For example, in some embodiments, the push notification can be sent to both User Terminal 101A and User Terminal 101B (if both are registered). In a preferred embodiment, the push notification can be sent only to those devices that are registered to the legitimate user, and which had not initiated the request for masked credentials. In the example discussed above, where User Terminal 101A had initiated the request for masked credentials, the push notification would therefore go to User Terminal 101B. In other embodiments, the push notification can be sent to one or more User Terminals that had been designated beforehand by the user for receiving push notifications. In some embodiments, the push notification can be sent to all User Terminals associated with the user. The push notification can notify the user regarding the action taken by the user (e.g., the action of navigating to Third Party Website 103 with a form field 106, and requesting to fill in masked credentials) on the user's terminal 101A.

The push notification can give the user the option to approve or disallow the filling in of masked credentials. If the user elects to approve the filling in of masked credentials, the user can provide input to the push notification or otherwise notify push notification platform 108 to allow the transaction. Once the Transaction Gateway 104 receives the affirmation to automatically fill information from the Push Notification Platform 108, the Server can alert the Privacy Tool 101AA to fill the requested information into the Third Party Website Form 106. Alternatively the user can select to deny the filling of the requested information by responding in the negative to the push notification sent via the Push Notification Platform 108. In this case, the Transaction Gateway 104 can send a message to the Privacy Tool Application 101AA that prevents the User Terminal 101A from providing the requested sensitive information to the Third Party Website Form 106.

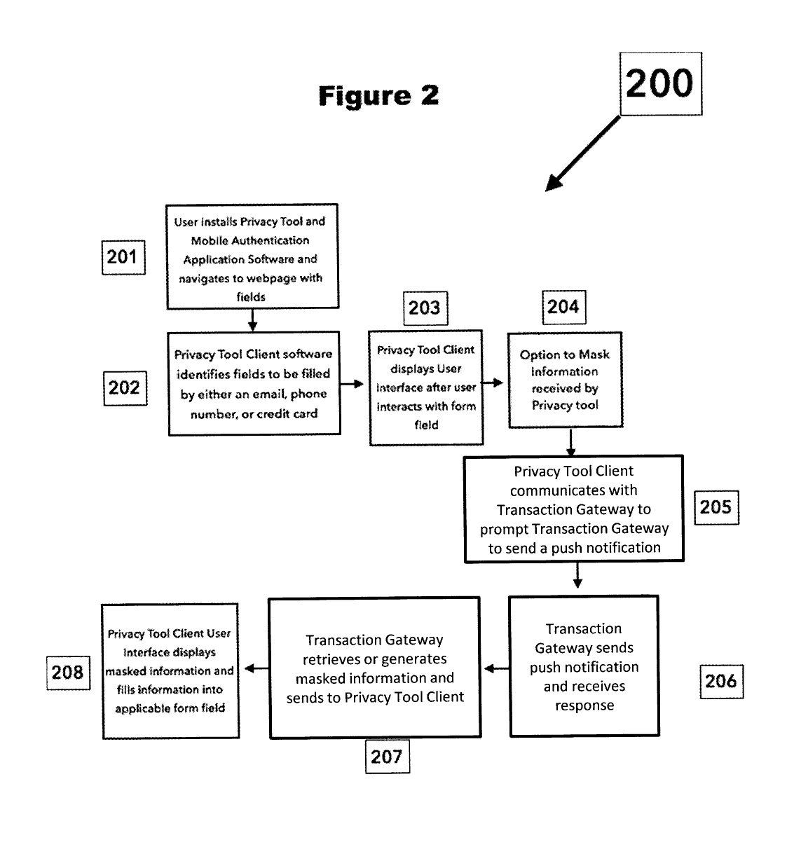

FIG. 2 is a flowchart depicting an exemplary process 200 by which Privacy Tool 101AA installed on User Terminal 101A interacts with a website form 106, according to some embodiments.

At step 201, the user installs the Privacy Tool application 101AA onto the user's device 101A. In some embodiments, the Privacy Tool application can be a browser plug-in that is installed into a web browser on the user's personal computer (PC). In other embodiments, the Privacy Tool application can be an application installed on the user's mobile device. As part of the installation process, the user sets up an account with the Privacy Tool Transaction Gateway 104, wherein the user specifies an ID and communication information for at least one device that is registered with the user. Once the Privacy Tool application is installed, the user then uses the device 101A to navigate to a webpage 103 with a form field 106 requesting user credentials.

At step 202, the Privacy Tool application 101AA detects that the webpage 103 includes form field 106 requesting user credentials. In some embodiments, the Privacy Tool application can also detect what type of user credentials are being requested, e.g., whether the form field 106 is requesting an email address, a phone number, and/or a credit card number.

At step 203, the Privacy Tool application 101AA can display a user interface to the user. In some embodiments, the Privacy Tool application 101AA can wait until the user interacts with a form field (e.g., by clicking into the form field) before displaying the user interface. The user interface can be different depending on the type of credential being requested (e.g., email, phone or credit card number). The user interface can give the user the option to (i) fill in the user's real credentials, (ii) fill in previously generated masked credentials, or (iii) generate new masked credentials. Masked credentials can include, for example, an email address, a phone number, a credit card number, a login username, or a login password. For example, if the form field 106 requests an email address, the user interface displayed by the Privacy Tool application 101AA can be a small window that appears adjacent to (e.g., below) the form field 106, and which gives the user the option to (i) use the user's real email address, (ii) use a previously generated masked email address, or (iii) generate a new masked email address.

At step 204, the Privacy Tool application 101AA can receive (via the user interface displayed in step 203) input from the user. If the Privacy Tool application 101AA receives input indicating that the user prefers option (ii) or option (iii), the process 200 proceeds to step 205. If the Privacy Tool application 101AA receives other input, the process 200 can terminate.

At step 205, the Privacy Tool application 101AA can communicate with the Transaction Gateway 104 and notify the server that a user is requesting the filling in of masked credentials. The Transaction Gateway 104 can, via the Push Notification Platform 108, alert the user through a push notification that a form field is being interacted with and that the decision to provide masked information has been selected. This prompting by the Push Notification Platform 108 can be sent to any or all of the user's terminals. In some embodiments, the push notification can be sent to both User Terminal 101A and User Terminal 101B (if both are registered). In a preferred embodiment, the push notification can be sent only to those devices that are registered to the legitimate user, and which had not initiated the request for masked credentials. In the example discussed above, where User Terminal 101A had initiated the request for masked credentials, the push notification would therefore go to User Terminal 101B. In yet other embodiments, the push notification can be sent to one or more User Terminals that had been designated beforehand by the user for receiving push notifications. In some embodiments, the push notification can be sent to all User Terminals associated with the user. Once the user has received this notification, the user can choose to authenticate or allow the transaction (e.g., the filling in of masked credentials) via the Privacy Tool. Alternatively, the user can choose to disallow the transaction.

At step 206, Transaction Gateway 104 can receive a response from the user indicating whether the user has decided to allow or disallow the transaction. If the user allows the transaction, the process 200 proceeds to stage 207. If the user chooses to disallow the transaction, the Transaction Gateway 104 can notify the Privacy Tool Application 101AA to prevent the filling in of the requested information into Website Form 106. In this case, the Privacy Tool Application 101AA will terminate the transaction and will not allow the User Terminal 101A to provide the requested information to Website Form 106 or the Third Party Website 103.

At step 207, the Transaction Gateway 104 requests the appropriate masked credentials from the Anonymous Credential Server Platform 105. If the requested credential is an email address, Anonymous Credential Server Platform 105 can query Email Platform 105A. If the requested credential is a phone number, Anonymous Credential Server Platform 105 can query Phone Platform 105B. If the requested credential is a credit card number, Anonymous Credential Platform 105 can query Credit Card Platform 105C. Each of Email Platform 105A, Phone Platform 105B, and Credit Card Platform 105C can include, or be coupled to, one or more data stores for storing previously generated masked credentials associated with different users. Each of Email Platform 105A, Phone Platform 105B, and Credit Card Platform 105C can be capable of both generating a new masked credential for a user upon request. Depending on the request from Device 101A and from Transaction Gateway 104, each of the platforms 105A, 105B, and 105C can either retrieve a previously generated masked credential associated with the user or generate an entirely new masked credential associated with the user. The Anonymous Credential Server Platform 105 can return the appropriate masked credentials to Transaction Gateway 104, which can then forward the masked credentials back to the Privacy Tool Application 101AA on the User Terminal 101A.

At step 208, the Privacy Tool Application 101AA can then populate the returned masked credentials into the website form field 106.

The process described above in relation to FIG. 2 is exemplary only and can be modified by adding, deleting, combining, or re-arranging steps. For example, the push notification and user response described above in relation to step 206 can be sent and received earlier or later in process 200, e.g., after the Transaction Gateway 104 has gathered the required information from the Anonymous Credential Server Platform 105.

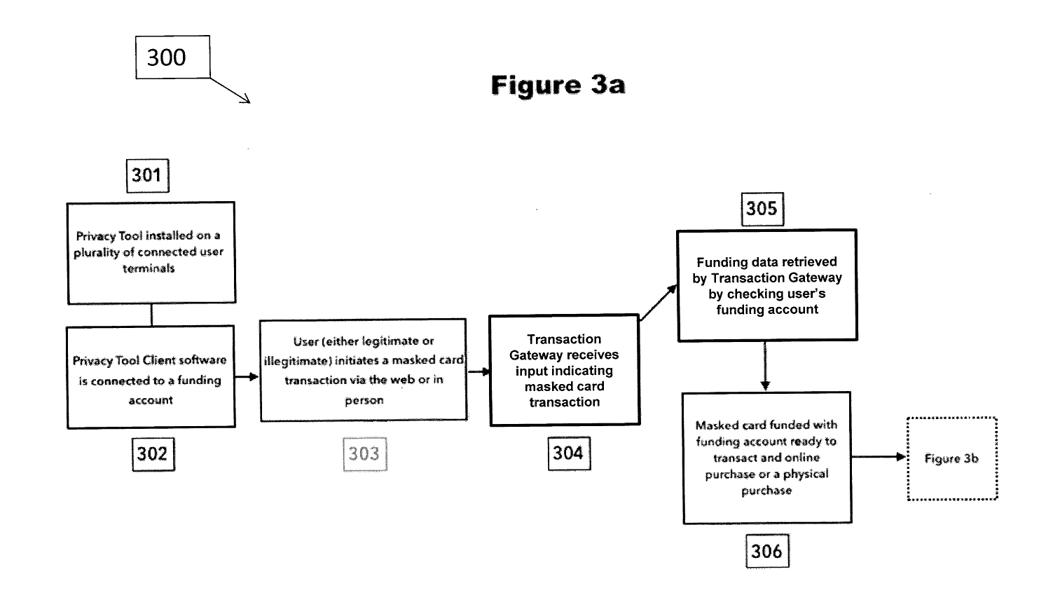

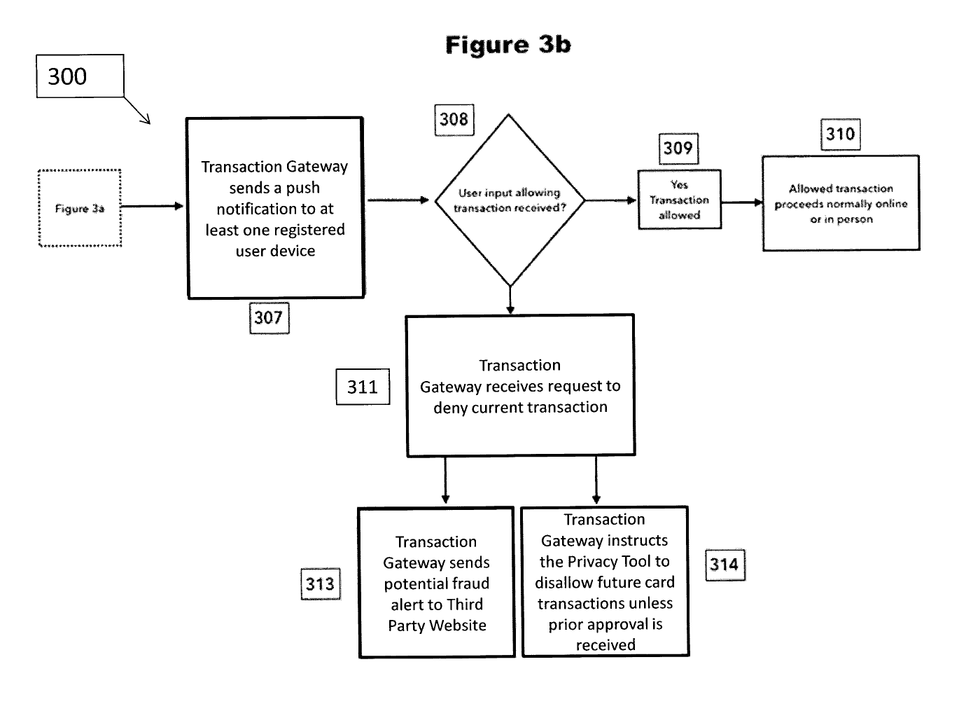

FIGS. 3a and 3b are flowcharts depicting an exemplary process 300 by which the Privacy Tool 101AA can alert a legitimate user to the fact that masked information is being created and/or used on the legitimate user's behalf to conduct a transaction, and by which the legitimate user can either allow or disallow such a transaction, according to some embodiments. FIGS. 3a, 3b and the following description focuses on the embodiment in which Privacy Tool 101AA is used to create and use a masked credit card; however, other embodiments in which Privacy Tool 101AA is used to mask other types of information (e.g., email addresses and/or phone numbers) are also possible.

At step 301, a user can install the Privacy Tool software 101AA onto the user's terminal 101A (personal computer, mobile device, tablet, etc.).

At step 302, the user can connect the Privacy Tool 101AA to a funding account (e.g., via the Credit Card Platform 105C, which communicates with the user's funding account 105C1 and/or online wallet 105C2) to transact masked purchases. This step can be part of a user registration process, whereby the user creates an account with the Transaction Gateway 104. As described above, the process of creating an account with the Transaction Gateway can require the user to provide the ID and contact information for at least one (and potentially many) registered devices.

At step 303, a user of User Terminal 101A (either legitimate or illegitimate) can initiate a masked transaction via the web or in person with a third party (e.g., a merchant or other party). When such a transaction is initiated, the Privacy Tool Application 101AA on User Terminal 101A can send a notification message to Transaction Gateway 104. A transaction could, for example, involve withdrawing funds from or depositing funds to the legitimate user's funding account, or could include debiting funds from a user's connected online wallet. The transaction could be “masked” in that, as described above, instead of providing the third party with information that is linked to the legitimate user's funding account (e.g., the legitimate user's real credit card number, or real bank account number), the Privacy Tool can provide the third party with a replacement piece of information. The replacement information can be linked to the legitimate user's funding account, but the linkage can be kept hidden or secret from the third party. In this way, the third party that possesses only the replacement information cannot independently locate or access the legitimate user's funding account. For example, the Privacy Tool can provide the third party with a credit card number that is not the user's real credit card number, but that is linked to a limited-duration, limited-balance credit card that is funded by the user's real credit card. The linkage between the replacement credit card number and the user's real credit card number can be kept secret from the third party. Similarly, the Privacy Tool can provide the third party with a bank account number that is not the user's real bank account number, but that is linked to a limited-duration, limited-balance bank account that is funded by the user's real bank account. The linkage between the replacement bank account number and the user's real bank account number can be kept secret from the third party.

The users funding account can be either a credit or debit card account, bank account, online wallet, or any kind of account that can be used to transact purchases. If the transaction is being conducted in person, the transaction can be accomplished with either a magnetic stripe interface or through near field communication technology embedded in the user's device 101A.

At step 304, the Transaction Gateway 104 receives user input indicating that the user wishes to initiate a masked transaction that accesses the user's credit card or bank card account, online wallet, or any funding account.

At step 305, the Transaction Gateway 104 can retrieve the necessary funding data by checking with the user's funding account to ensure that there are sufficient funds to proceed with a masked card transaction. If this retrieval step is successful, and if the Privacy Tool confirms that the user has sufficient funds to proceed with a masked card transaction, the Privacy Tool proceeds to step 306.

At step 306, the Privacy Tool confirms that all steps and information necessary to create a new masked card, or to use a previously generated masked card, have been fulfilled, and that the only step left to be completed is to receive the legitimate user's authorization in response to a push notification.

Turning now to FIG. 3B, at Step 307, the Privacy Tool can first consult the Transaction Gateway 104 to ascertain which registered user devices should receive the upcoming push notification. The push notification can be sent to any number of the user's connected devices 101A or 101B via the Push Notification Platform 108, informing the user that a transaction is being undertaken with the user's funding account or online wallet (306). In response to the push notification, the user of connected user devices 101A and/or 101B can respond with an authorization to proceed with the transaction, or with a message forbidding the transaction from proceeding.

At step 308, the Transaction Gateway 104 receives a response from at least one of user's connected devices 101A and/or 101B. As discussed above, the response can comprise an authorization to proceed with the transaction, or with a message forbidding the transaction from proceeding. If the response comprises an authorization to proceed, the process 300 branches to step 309. If the response comprises a message forbidding the transaction from proceeding, the process 300 branches to step 311.

At step 309, the Transaction Gateway 104 requests the appropriate masked credentials from the Anonymous Credential Server Platform 105. The requested credential can be a credit card number, wherein the Anonymous Credential Platform 105 can query Credit Card Platform 105C. The Credit Card Platform 105C can then determine whether the user wants to fund the transaction via the user's funding account 105C1 or online wallet 105C2. The Anonymous Credential Server Platform 105 can return the appropriate masked card credentials to Transaction Gateway 104, which can then forward the masked credentials back to the Privacy Tool Application 101AA on the User Terminal 101A.

At step 310, the Privacy Tool Application 101AA on the User Terminal 101A uses the masked credentials to consummate the transaction. As discussed above, the transaction can be conducted purely online (e.g., a purchase or other transaction conducted via the world wide web), and the transaction can be consummated in the form of an online checkout. Alternatively, if the User Terminal 101 contains NFC or magnetic stripe technology, the transaction can be consummated using an in-person checkout, whereby User Terminal 101A is held up to a card scanner or NFC reader that reads and interacts with the masked credentials.

At step 311, the Transaction Gateway 104 can receive the request to disallow the transaction from the Push Notification Platform 108. Upon receiving the request to disallow the transaction, the Transaction Gateway 104 can perform several actions. Steps 313 and 314 described below present two potential, optional actions that can be performed by the Transaction Gateway when it receives a request to disallow a transaction.

At step 313, the Transaction Gateway 104 can contact the Third Party Website 103 to alert domain owners that fraudulent activity has been undertaken and should be disallowed going forward. Transaction Gateway 104 can also send an email, text, phone call, physical mail, or other communication to the legitimate user of User Terminal 101A indicating that potentially fraudulent activity involving User Terminal 101A was detected.

At step 314, the Transaction Gateway 104 can also instruct the Privacy Tool to disallow all future card transactions unless prior approval is received via the Push Notification Platform 108 by any of the user's connected devices 101A and/or 101B with the Privacy Tool Application 101AA or 101BB installed. If an illegitimate user obtained the legitimate user's connected devices and tried to transact with a previously created masked card, the Transaction Gateway 104, can also instruct the Privacy Tool to disallow a card transaction even though the masked card was created before the moment of the transaction.

FIGS. 3a and 3b includes the scenario where an illegitimate user gains access to User Terminal 101A. For example, the illegitimate user could steal the legitimate user's smartphone or laptop, or gain access to it while the legitimate user is away from the device (e.g., while away from home, or away from his/her desk). The process 300 described in FIGS. 3a and 3b prevent the illegitimate user from conducting transactions without the legitimate user's knowledge and approval. However, other scenarios are also possible.

Suppose an illegitimate user gains access not to User Terminal 101A, but to a masked credit card number associated with the legitimate user. Suppose further that the illegitimate user uses a third device (not shown) to conduct a transaction using the masked credit card number. As long as the third device has a Privacy Tool Application installed, the third device can still send a notification to Transaction Gateway 104 that someone is attempting to use a masked credit card number. By consulting database records storing information relating to registered user accounts, Transaction Gateway 104 can determine the legitimate user associated with the masked credit card number being used by the illegitimate user. The Transaction Gateway 104 can send a push notification to one or both of the legitimate user's devices, e.g., User Terminals 101A and 101B, and the legitimate user can still approve or deny the transaction by responding to the push notification. If the legitimate user denies the transaction, the Transaction Gateway 104 can send a message to the Privacy Tool Application installed on the third device (e.g., the device being used by the illegitimate user) that prevents the transaction from going forward. This can be done by, for example, having the Privacy Tool Application installed on the third device prevent the filling in of the masked credit card number to a website field. In this scenario, even though the legitimate user's devices 101A and 101B never left the legitimate user's possession, the disclosed push notification scheme can still prevent unauthorized use of the legitimate user's masked credit card information.

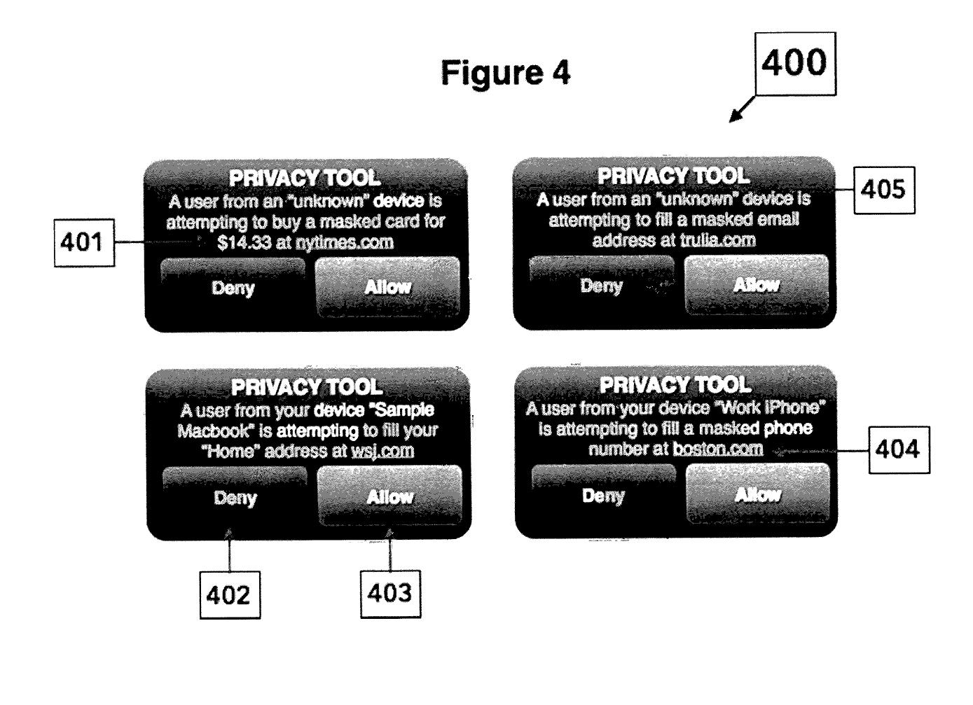

FIG. 4 is an illustration of the mobile push notification 400 sent by the Push Notification Platform 108 to any of the user's connected devices 101A and/or 101B with the Privacy Tool Application 101AA or 101BB installed in response to the creation of a masked card depicted in FIG. 3. The user can be presented with the amount of the transaction 401, and the website where the transaction was undertaken 404. The user can also be presented with the identity of the device on which the transaction was initiated 405. If the device is recognized to be one of the legitimate user's devices, the device identity 405 can display message such as “Sample Macbook” or “Work iPhone.” If, however, the device is not recognized to be one of the legitimate user's devices, the device identity 405 can display a message such as “an ‘unknown’ device.” The user can also be presented with an “allow” (403) or “deny” (402) button(s), that the user can interact with to send the appropriate message to the Transaction Gateway 104, via the Push Notification Platform 108, that can either allow or disallow the transaction. In some embodiments, for additional security, the user can be required to enter a passcode or password, or provide a fingerprint reading, before the user can allow the transaction.

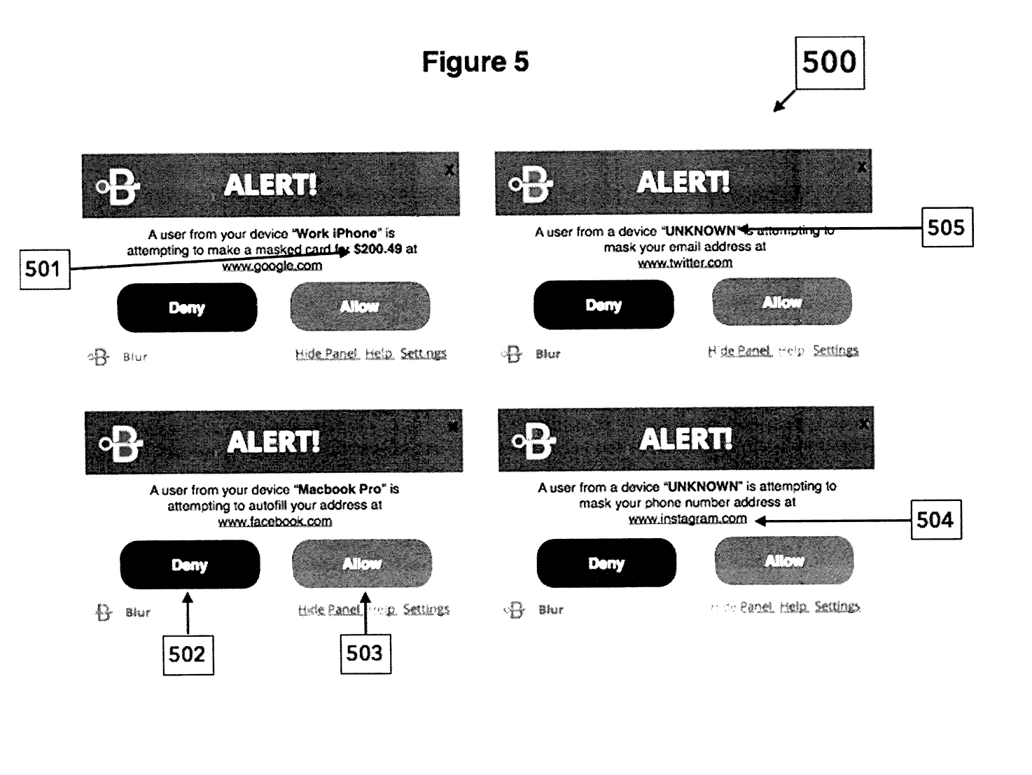

FIG. 5. is an illustration of the Desktop push notification 500 sent by the Push Notification Platform 108 to any of the user's connected devices 101A and/or 101B with the Privacy Tool Application 101AA or 101BB installed in response to the creation of a masked card depicted in FIG. 3. The user can be presented with the amount of the transaction 501, the website where the transaction was undertaken 504, and the device on which the transaction was initiated 505. As discussed above, if the device is recognized to be one of the legitimate user's devices, the device identity 405 can display message such as “Macbook Pro” or “Work iPhone.” If, however, the device is not recognized to be one of the legitimate user's devices, the device identity 405 can display a message such as “an ‘unknown’ device.” The user can be presented with an “allow” (503) or “deny” (502) button(s), that the user can interact with to send the appropriate message to the Transaction Gateway 104, via the Push Notification Platform 108, that can either allow or disallow the transaction. In some embodiments, for additional security, the user can be required to enter a passcode or password, or provide a fingerprint reading, before the user can allow the transaction.

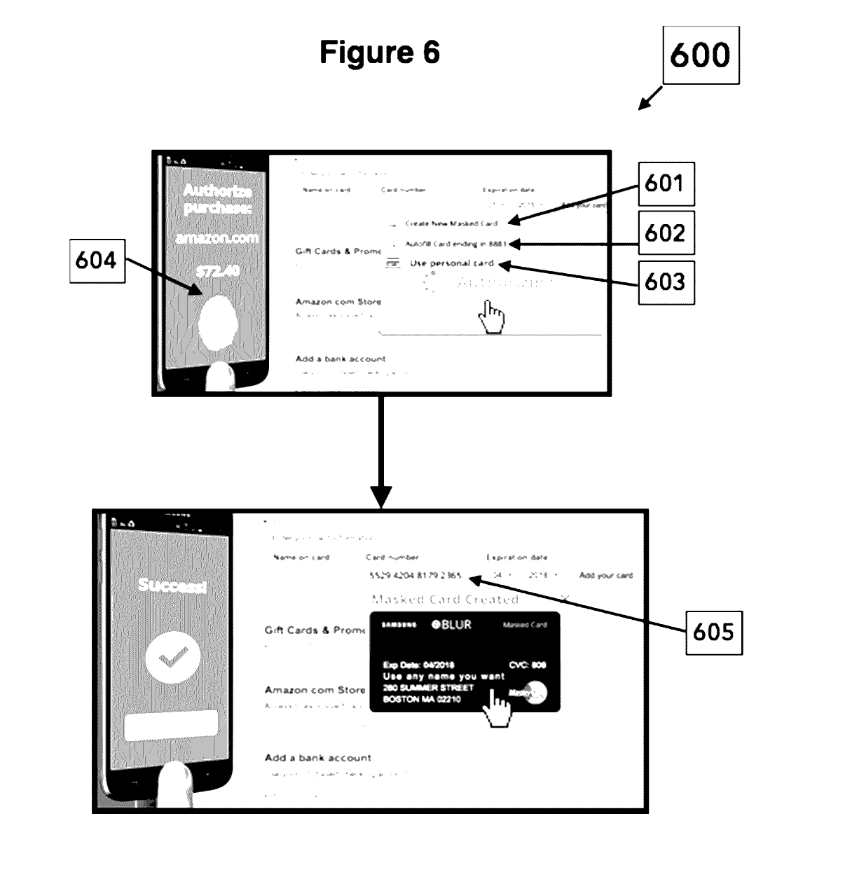

FIG. 6 displays a user interface 600 displayed by the Privacy Tool Application when the user (either legitimate or illegitimate) clicks into a website form field. In some embodiments, application 101AA can wait until the user interacts with a form field (e.g., by clicking into the form field) before displaying the user interface 600. The user interface can be different depending on the type of credential being requested (e.g., card number here depicted). The user interface can give the user the option to (i) fill in the user's real credentials (603), (ii) fill in previously generated masked credentials (602), or (iii) generate new masked credentials (601). If the user selects “Create New Masked Card”, the Transaction Gateway 104 can communicate with the Credit Card Platform 105C via the Anonymous Credential Server Platform 105 and can select the appropriate funding source (either 105C1 or 105C2). If the user selects to fill in a previously generated card, the Transaction Gateway 104 can communicate with the Credit Card Platform 105C via the Anonymous Credential Server Platform 105 to retrieve information linked with the selected card (e.g., the full masked credit card number). Once the appropriate funding source has been selected or the information linked to the selected card has been retrieved, the Transaction Gateway can communicate with the Push Notification Platform 108 to send the user a push notification to any of the user's connected devices 101A and/or 101B with the Privacy Tool Application 101AA or 101BB. The user can see the notification on either device and can (as the illustration shows) affirm the creation of a new card or the use of a previously generated card with a button press, fingerprint scan, password/passcode or other ways of confirming a selection 604. Once the user makes the affirmation to create the Masked Card, the Push Notification Platform 108 can communicate back to the Transaction Gateway 104 that can allow the user funding account 105C1 or online wallet 105C2 to supply the requisite funding to create the Masked Card (or use the debit the previously generated card) for the amount requested. Once the Transaction Gateway (104) receives the affirmation to automatically fill information 605 from the Push Notification Platform (108), the Server can alert the Privacy Tool (101AA) to fill the requested information into the Third Party Website Form (106). Alternatively the user can select to deny the filling of the requested information by responding in the negative to the push notification sent via the Push Notification Platform (108).

The processes described above are exemplary and not limiting. Any of the processes can be altered, e.g., by having steps added, altered, removed, or rearranged. Many other alternatives are possible.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A transaction gateway for preventing fraud by enabling a user to control whether a masked transaction may be initiated with a third party, wherein the masked transaction is associated with a masked credential having a highly limited transaction history, the transaction gateway comprising:
a data store for associating a user with at least one user device;
at least one computer processor coupled to the data store configured to:
provide an interface to communicate with user devices;
receive from a first user device a request to initiate the masked transaction by submitting to the third party the masked credential, wherein the masked credential is associated with the user;
send to the at least one user device associated with the user a notification message requesting that the user approve or deny submission of the masked credential;
receive a reply message from the at least one user device associated with the user indicating whether submission of the masked credential is approved or denied;
if submission is approved, allow initiation of the masked transaction by allowing submission of the masked credential; and
if submission is denied, block initiation of the masked transaction by blocking submission of the masked credential.

2. The transaction gateway of claim 1, wherein the masked credential includes at least one of a masked email address, a masked mail address, a masked username, a masked password, a masked credit card number, a masked bank account number, and a masked phone number.

3. The transaction gateway of claim 1, wherein the at least one computer processor is further configured to send an alert message indicating potentially fraudulent activity to the third party if submission of the masked credential is denied.

4. The transaction gateway of claim 1, wherein the at least one user device associated with the user is different from the first user device.

5. The transaction gateway of claim 1, wherein the at least one user device associated with the user is the same as the first user device.

6. The transaction gateway of claim 1, wherein the third party comprises a website having a form for receiving the masked credential.

7. The transaction gateway of claim 1, wherein the at least one computer processor is further configured to generate the masked credential associated with the user in response to the request from the first user device.

8. The transaction gateway of claim 1, wherein the masked credential is a previously generated masked credential stored in the data store, and the request from the first user device includes a request to retrieve the previously generated masked credential.

9. The transaction gateway of claim 1, wherein the at least one computer processor allows submission of the masked credential by sending a message to the first user device that allows the first user device to submit the masked credential to the third party.

10. The transaction gateway of claim 1, wherein the at least one computer processor blocks submission of the masked credential by sending a message to the first user device that blocks the first user device from submitting the masked credential to the third party.

11. A method for preventing fraud by enabling a user to control whether a masked transaction may be initiated with a third party, wherein the masked transaction is associated with a masked credential having a highly limited transaction history, the method comprising:
receiving, at a transaction gateway, a request from a first user device to initiate the masked transaction by submitting to the third party the masked credential, wherein the masked credential is associated with the user;
sending, from the transaction gateway, a notification message to at least one device associated with the user requesting that the user approve or deny submission of the masked credential;
receiving, at the transaction gateway, a reply message from the at least one user device associated with the user indicating whether submission of the masked credential is approved or denied;
if submission is approved, allowing initiation of the masked transaction by allowing submission of the masked credential; and
if submission is denied, blocking initiation of the masked transaction by blocking submission of the masked credential.

12. The method of claim 11, wherein the masked credential includes at least one of a masked email address, a masked mail address, a masked username, a masked password, a masked credit card number, a masked bank account number, and a masked phone number.

13. The method of claim 11, further comprising sending an alert message indicating potentially fraudulent activity to the third party if submission of the masked credential is denied.

14. The method of claim 11, wherein the at least one user device associated with the user is different from the first user device.

15. The method of claim 11, wherein the at least one user device associated with the user is the same as the first user device.

16. The method of claim 11, wherein the third party comprises a website having a form for receiving the masked credential.

17. The method of claim 11, wherein the masked credential associated with the user is generated in response to the request from the first user device.

18. The method of claim 11, wherein the masked credential is a previously generated masked credential, and the request from the first user device includes a request to retrieve the previously generated masked credential.

19. The method of claim 11, wherein allowing submission of the masked credential comprises sending a message from the transaction gateway to the first user device that allows the first user device to submit the masked credential to the third party.

20. The method of claim 11, wherein blocking submission of the masked credential comprises sending a message from the transaction gateway to the first user device that blocks the first user device from submitting the masked credential to the third party.
